(19) United States
(12) Patent Application Publication
(10) Pub. No.: US 2024/0004191 A1
(43) Pub. Date: Jan. 4, 2024

(54) HEAD-UP DISPLAY DEVICE

(71) Applicant: EYELIGHTS, Labege (FR)

(72) Inventors: Patrice NAGTEGAELE, Toulouse (FR); Romain DUFLOT, Toulouse (FR)

(21) Appl. No.: 18/037,536

(22) PCT Filed: Nov. 18, 2021
(86) PCT No.: PCT/EP2021/082217

§ 371 Date: May 17, 2023

(30) Foreign Application Priority Data
Nov. 19, 2020 (FR) FR2011887

(51) Int. Cl. G02B 27/01

(52) U.S. Cl. CPC G02B 27/0101; B60K 35/00; G02B 2027/012; G02B 2027/0194

(57) ABSTRACT

The present invention relates to a head-up display device comprising:
a. a transparent carrier comprising an inlet optical interface and an outlet optical interface,
b. a reflector element arranged on one portion of the outer facet of the inlet optical interface,
c. A source for projecting information, which source is capable of emitting, in the direction of the reflector element, a light beam polarized according to a main polarization and referred to as the incident beam, the incident beam arriving on the reflector element at an incidence angle and defining, with the reflector element, an incidence plane, the main polarization being a polarization contained within the incidence plane, referred to as P-polarization,
the reflector element having a greater reflectivity, over a range of incidence angles including the incidence angle, for P-polarized light than for a rectilinear polarization light perpendicular to the incidence plane, which is referred to as S-polarization.

The present invention relates to a head-up display device. The present invention further relates to a vehicle comprising such a head-up display device.

A head-up display device conventionally comprises an information projection source able to generate a light beam towards a transparent support. The transparent support comprises an input device and an output optical interface. The reflection of the light beam on each of the optical interfaces creates two virtual images: a useful image obtained by reflection on the input optical interface and a spurious image obtained by reflection on the output optical interface. The spurious image, also called “ghost” affects the visibility of the useful image.

In order to limit the impact of the spurious image and enhance the brightness of the useful image, it is known to apply a semi-reflecting treatment to the input optical interface so as to increase the reflection on the optical interface and thereby decrease the quantity of light transmitted to the output optical interface. Furthermore, an antireflection treatment can be applied to the output optical interface so as to limit the reflections thereon. However, such a technique is not applicable when the transparent support is a windscreen. Indeed, an antireflection treatment applied to the external face of a windscreen would not be resistant to environmental conditions (weather, solar radiation, windscreen wiper blade).

Another known variation consists, instead of the antireflection treatment, in tinting the transparent support so as to absorb the light transmitted towards the output optical interface. However, for legal reasons, such technique is not applicable when the transparent support is a windscreen.

Another very widespread solution consists in creating a wedge at the structure of the transparent support. Such prismatic effect makes it possible to superimpose the reflection created by the input optical interface onto the reflection created by the output optical interface. However, in the case of windscreens, the combination between a windscreen (angle of inclination, curvature) and a head-up display requires the manufacture of a specific windscreen for each model of vehicle. The manufacture of the windscreen thus becomes more complex.

There is hence a need for a head-up display device for limiting the ghost effect relating to the spurious image without making the manufacture of the transparent support more complex, and which is compatible with all types of transparent supports, including the windscreen of a vehicle.

To this end, the subject matter of the present description is a head-up display device comprising:
a transparent support comprising an input optical interface and an output optical interface, each optical interface having an external face and an internal face opposite the external face,
a reflector element arranged on at least part of the external face of the input optical interface,
an information projection source able to emit, towards the reflector element, a light beam polarized according to a main polarization, called incident beam, the incident beam arriving on the reflector element at an angle of incidence and defining with the reflector element a plane of incidence, the main polarization being a polarization contained in the plane of incidence, called polarization P, the reflector element having a greater reflectivity, over a range of angles of incidence including the angle of incidence, for a light with polarization P than for a light with rectilinear polarization perpendicular to the plane of incidence, called polarization S.

According to other advantageous aspects, the device comprises one or a plurality of the following features, taken individually or according to all technically possible combinations:
the reflector element has a greater reflectivity, over the range of angles of incidence, for a light with polarization P than for a light with a different polarization;
the reflectivity of the reflector element for a light with polarization P, over the range of angles of incidence, is greater than or equal to 10 percent, preferentially greater than or equal to 15 percent, advantageously greater than or equal to 20 percent, even more advantageously greater than or equal to 40 percent;
the reflectivity of the reflector element for light with a polarization other than a polarization P, over the range of angles of incidence, is less than or equal to 10 percent, preferentially less than or equal to 5 percent;
the range of angles of incidence extends over at least 20 degrees, preferentially at least 40 degrees, advantageously at least 60 degrees;
the range of angles of incidence includes a Brewster angle with respect to the input optical interface;
the information projection source is configured for emitting the incident beam with an angle of incidence chosen so that the portion of the incident beam transmitted by the reflector element arrives at the output optical interface at an angle substantially equal to the Brewster angle with respect to the output optical interface;
the reflector element comprises a stack of dielectric layers;
the transparent support is a windscreen of a vehicle, the reflector element being advantageously arranged over the entire external face of the input optical interface.

The present description further relates to a vehicle comprising a head-up display device such as described hereinabove.

Other features and advantages of the invention will appear upon reading the following description which follows embodiments of the invention, given only as a limiting example, and making reference to the following drawings:

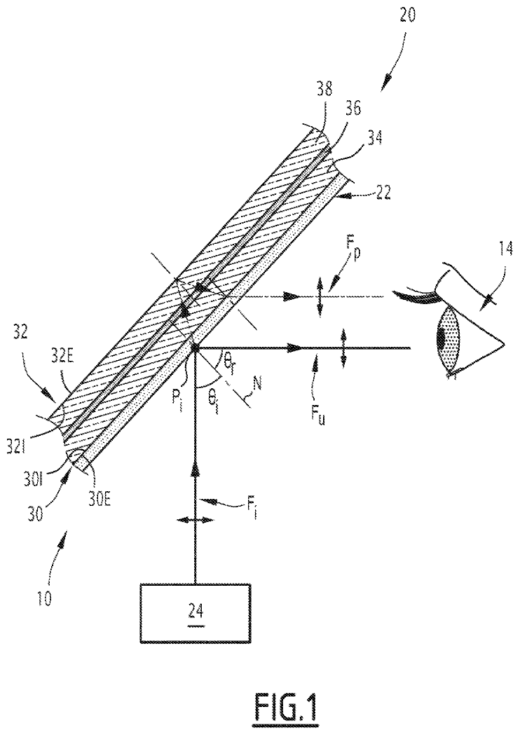

FIG. 1 is a schematic representation of an example of a head-up display device, and

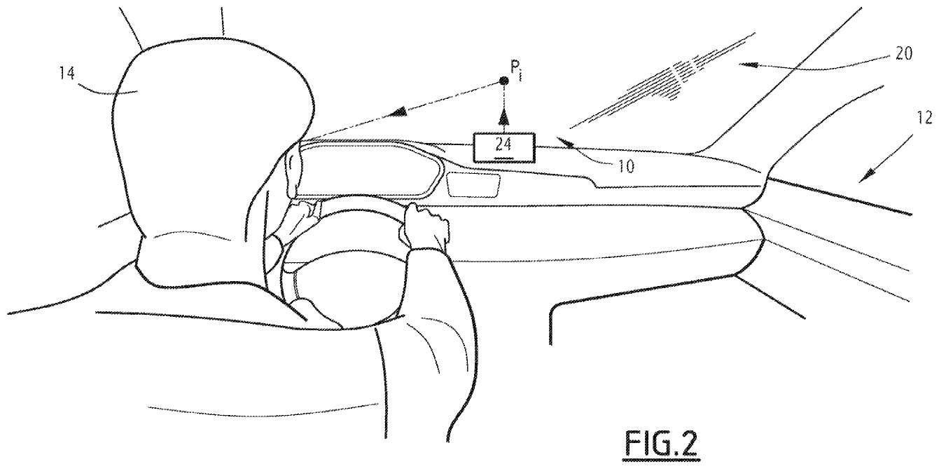

FIG. 2, a schematic perspective view of an example of the interior of a vehicle comprising the head-up display device shown in FIG. 1.

A head-up display system 10 is shown in FIGS. 1 and 2.

As illustrated in FIG. 2, the device 10 is suitable for being integrated into a vehicle 12. The vehicle is e.g. a land, an aerial or a naval vehicle. The land vehicle is e.g. a motor vehicle (FIG. 2) or a railway vehicle.

The device 10 is suitable for displaying information within the field of vision of the driver 14 of the vehicle 12. The information is e.g. supplied by instruments on board the vehicle 12. As an example, the information relates to a speed indicator of the vehicle 12, to the energy consumption of the vehicle 12, to alarms relating to the malfunction of certain components of the vehicle 12 or to navigation information (mapping, positions, directions).

The device 10 comprises a transparent support 20, a reflector element 22 and an information projection source 24.

The transparent support 20 comprises an input optical interface 30 and an output optical interface 32. The input optical interface 30 has an external face 30E and an internal face 301 opposite the external face 30E. The output optical interface 32 has an external face 32E and an internal face 321 opposite the external face 32E. The external face 30E, 32E of each optical interface 30, 32 is a face oriented towards the outside of said optical interface 32, i.e. towards the external environment (air). The internal face 301, 321 of each optical interface 30, 32 is oriented towards the inside of said optical interface 30, 32.

The transparent support 20 comprises at least one layer of a transparent material between the input optical interface 30 and the output optical interface 32. The transparent material is e.g. glass or plastic.

In one embodiment, the transparent support 20 comprises a plurality of layers of transparent materials, different if appropriate, between the input optical interface 30 and the output optical interface 32. The materials of said layers are e.g. glass, ethylene vinyl acetate (EVA), or polyvinyl butyral (PVB).

In particular, in the example illustrated by FIG. 1, the transparent support 20 comprises a first layer 34 of glass, a second layer 36 of PVB and a third layer 38 of glass. In said example, it is considered that the indices of the materials of the different layers are substantially identical, and do not induce additional spurious reflections at the interfaces.

The transparent support 20 is e.g. a panel also called a “combiner”. In a variant, the transparent support 20 is a windscreen, such as the windscreen of the vehicle 12 wherein the device 10 is integrated.

The reflector element 22, also called a reflective polarizer, is an element arranged on at least part of the external face 30E of the input optical interface 30. The term “arranged” means that the reflector element 22 is applied (hence in contact) to the external face 30E of the input optical interface 30, and adheres to the face (if appropriate, by a means of attachment). The reflector element 22 is thereby rigidly attached to the external face 30E of the input optical interface 30. The reflector element 22 is e.g. a coating or treatment (e.g. obtained by physical deposition or chemical deposition) or a film (e.g. laminated or held by electrostatic effect).

When the transparent support 20 is a windscreen of a vehicle, the reflector element 22 is advantageously arranged over the entire external face 30E of the input optical interface 30. Thereby, the reflector element 22 becomes invisible to the user (no patch effect).

The reflector element 22 is an element able to reflect an incident light beam Fᵢ having a given range of wavelengths, as according to the angle of incidence Θᵢ of the incident beam Fᵢ on the reflector element 22 and of the polarization of said incident beam Fᵢ.

The given range of wavelengths of the incident beam Fᵢ belongs e.g. to the visible range (380 nanometers to 700 nanometers).

The angle of incidence Θᵢ of the incident beam Fᵢ is the angle between the axis of the beam and the normal N to the reflector element 22 at the point of incidence Pᵢ of the incident beam Fᵢ on the reflector element 22. The axis of the incident beam Fᵢ and the normal N to the reflector element 22 at the point of incidence Pᵢ define a plane of incidence. In the example illustrated by FIG. 1, the reference line is the plane of the figure. In particular, the reflector element 22 is able to reflect at least a part of the incident beam Fᵢ in order to form a useful virtual image observable from an observation window (corresponding to a useful beam F_{U}) and to transmit at least one other part of the incident beam Fᵢ to the output optical interface 32. The output optical interface 32 is, where appropriate, able to reflect part of the beam transmitted by the reflector element 22 so as to form a spurious virtual image observable from the observation window (corresponding to a spurious beam F_{P}).

Hereinafter, a rectilinear polarization contained in the plane of incidence is also called polarization P, and a rectilinear polarization perpendicular to the plane of incidence is also called polarization S.

The reflector element 22 is optimized for reflecting light with polarization P. The reflector element 22 thereby has a greater reflectivity over a range of angles of incidence and over the given range of wavelengths, for a light of polarization P, than for a light of different polarization (polarization S, circular polarization, elliptical polarization).

Advantageously, the reflectivity of the reflector element 22 for a light with polarization P, over the range of angles of incidence and over the given range of wavelengths, is chosen so as to be compatible with the transparency criteria imposed on the windscreens of motor vehicles (so that the reflector element 22 remains transparent and does not alter the driver's perception), while being sufficiently high for the “ghost” effect to be negligible. To this end, the reflector element 22 is e.g. such that the signal-to-noise ratio between the useful beam and the spurious beam is less than or equal to 3 percent, preferentially less than or equal to 1 percent, advantageously less than or equal to 0.5 percent.

Preferentially, the reflectivity of the reflector element 22 for light with polarization P, over the range of angles of incidence and over the given range of wavelengths, is greater than or equal to 10 percent, preferentially greater than or equal to 15 percent, advantageously greater than or equal to 20 percent, advantageously greater than or equal to 40 percent.

Advantageously, the reflectivity of the reflector element 22 for light with a polarization different from a polarization P, over the range of angles of incidence and over the given wavelength range, is less than or equal to 10 percent, preferentially less than or equal to 5 percent.

Advantageously, the range of angles of incidence extends over at least 20 degrees, preferentially at least 40 degrees, advantageously at least 60 degrees.

Preferentially, the range of angles of incidence Θᵢ comprises the Brewster angle between the external environment (air) and the transparent support at the input optical interface (typically 56° for an air-glass interface). The reflector element 22 is configured for making the effect of the Brewster angle nonexistent, i.e. the polarization P does not cancel out at the Brewster angle. It is recalled that the Brewster angle is the angle of incidence of an incident beam on an optical interface for which the beam is not reflected on the optical interface if the optical interface has a polarization P.

The reflector element 22 comprises e.g. a stack of dielectric layers.

The reflector element 22 is e.g. a polarizer with a specific reflectivity for polarized light P, as described in the patent application WO 96/19347 A.

In particular, the reflector element 22 comprises e.g. a multilayer polymer film comprising layers of a crystalline or semi-crystalline naphthalene dicarboxylic acid polyester, e.g. a 2,6-polyethylene naphthalate (“PEN”) or a copolymer derived from ethylene glycol, naphthalene dicarboxylic acid and certain other acids such as terephthalate (“co-PEN”), with a positive stress-optical coefficient, i.e. during stretching, the refractive index thereof along the stretching direction increases, having an average thickness not exceeding 0.5 micron; and layers of a second selected polymer, such as polyethylene terephthalate (“PET”) or a co-PEN, having an average thickness which does not exceed 0.5 micron.

In another example, the reflector element 22 comprises a multilayer polymer film comprising layers of a crystalline or semi-crystalline polyester, e.g. a PET, having an average thickness not exceeding 0.5 micron; and layers of a second selected polymer, such as a polyester or a polystyrene, having an average thickness not exceeding 0.5 micron; wherein said film has been stretched in at least one direction to at least twice the unstretched dimension of said direction.

In one embodiment, the reflector element 22 also has at least one coating imparting additional optical and/or mechanical properties. The coating is e.g., a thermal protection, a neutralizing colorimetric treatment or an anti-scratch or anti-fog coating.

In addition or in a variant, the reflector element 22 is configured so as to reflect, over the range of angles of incidence, each amongst the P-polarized light and S-polarized light with a high reflectivity (typically greater than or equal to 50%) in the infrared range (at least near infrared: 700 μm to 1 μm). In particular, in this way it is possible to reject more solar radiation.

The information projection source 24 is able to emit a light beam incident on the reflector element 22. The incident beam Fᵢ carries information which is e.g. such as described hereinabove.

The incident beam Fᵢ emitted by the information projection source 24 is a beam polarized according to a specific polarization, called main polarization.

The main polarization is a rectilinear polarization contained in the plane of incidence, called polarization P. The main polarization is thus different from a polarization S, a circular polarization or an elliptical polarization.

The wavelengths of the incident beam Fᵢ lie within the wavelength range given for the reflector element 22, typically in the visible range.

The information projection source 24 is configured so that the incident beam Fᵢ arrives at the reflector element 22 with an angle of incidence Θᵢ within the range of angles of incidence defined beforehand for the reflector element 22.

Advantageously, the information projection source 24 is configured for sending the incident beam Fᵢ onto the reflector element 22 with an angle of incidence Θᵢ such that the beam transmitted by the reflector element 22 arrives on the output optical interface 32 with an angle substantially equal to the Brewster angle between the middle of the transparent support 20 and the external environment (air) (typically 33° for a glass-air interface), or within a range of angles extending over 10 degrees around said Brewster angle. Since the incident beam has a polarization P, it is thereby possible to completely eliminate the spurious reflection on the output optical interface 32.

The operation of the head-up display device 10 will now be described.

Initially, the information projection source 24 sends an incident light beam polarized along the main polarization towards the reflector element 22. The incident beam Fᵢ lies within the given wavelength range, typically in the visible. The incident beam Fᵢ arrives at the reflector element 22 with an angle of incidence Θᵢ with respect to a normal N to the reflector element 22 at the point of incidence Pᵢ.

The reflector element 22 then reflects at least part of the incident beam Fᵢ so as to form a useful virtual image observable from an observation window. Since the incident beam Fᵢ has a polarization P and the angle of incidence Θᵢ of the beam on the reflector element 22 is comprised in the range of angles of incidence, the quantity of reflected incident beam Fᵢ is maximized with respect to an incident beam Fᵢ with polarization S, and more generally with a polarization different from P.

The reflector element 22 also transmits at least another part of the incident beam Fᵢ towards the output optical interface 32.

Depending on the angle of incidence Θᵢ the output optical interface 32 either reflects or does not reflect a part of the beam transmitted by the reflector element 22 and the input optical interface 30, so as to form a spurious virtual image observable from the observation window.

When such is the case, the quantity of light reflected on the output optical interface 32 is however relatively small. E.g., for a main polarization of type P, the quantity of light reflected on the output optical interface 32 is typically on the order of 1 to 2 percent for an angle of incidence Θᵢ of 65 degrees. On the other hand, if the main polarization were of the type S, the quantity of light reflected on the output optical interface 32 would be rather on the order of 20 percent for an angle of incidence Θᵢ of 65 degrees.

Furthermore, for an angle of incidence chosen so that the beam transmitted by the reflector element 22 arrives at the output optical interface 32 at an angle substantially equal to the Brewster angle between the middle of the transparent support 20 and the external environment (air), the quantity of light reflected on the output optical interface 32 is zero or almost zero (no spurious reflection).

Thereby, the head-up display device 10 makes it possible to superimpose information useful for driving in the field of vision of a driver.

The combination of a reflector element 22, optimized for reflecting a light with polarization P, and of an information projection source 24 emitting a light beam polarized along a polarization P, increases the quantity of reflected useful light compared to the quantity of reflected spurious light.

More particularly, for a polarization P, the percentage of reflected spurious light is small compared to the percentage of reflected useful light, which makes the ghost effect relatively negligible. Moreover, for specifically chosen angles of incidence Θᵢ, the percentage of reflected spurious light is almost zero, or even zero.

Furthermore, a polarization P has the advantage of being compatible with polarized sunglass lenses. Such lenses are in fact conventionally configured for transmitting only the P-polarized light, and to reject the other types of polarizations.

Moreover, the addition of a reflector element 22 on the transparent support 20 is easy to implement since no modification of the structure of the support 20, nor of the internal layer or layers of the support 20, is involved. The reflector element 22 has, in particular, the same configuration regardless of the structure of the transparent support 20 (angle of inclination, curvature), which is not the case with the prism (wedge) solutions of the prior art. Thereby, the manufacture of the transparent support 20 is not more complex and the device 10 is adaptable to all types of transparent supports, both combiners and windscreens.

A person skilled in the art would understand that the embodiments described hereinabove are likely to be combined with one another when such combinations are compatible.

The embodiments described are also adaptable with a prismatic structure. In such complement, the output optical interface 32 is inclined with respect to the input optical interface 30 (“wedge”) so as to superimpose the spurious virtual image over the useful virtual image. Such a complement makes it possible to further limit the ghost effect because the spurious image already strongly attenuated by the specific configuration of the device 10 is, furthermore, superimposed over the useful image.

1-10. (canceled)

11. A head-up display device comprising:
a. a transparent support comprising an input optical interface and an output optical interface, each optical interface having an external face and an internal face opposite the external face,
b. a reflector element arranged on at least a part of the external face of the input optical interface,
c. an information projection source able to emit, towards the reflector element, a light beam polarized along a main polarization, called incident beam, the incident beam arriving on the reflector element at an angle of incidence and defining with the reflector element, a plane of incidence, the main polarization being a polarization contained in the plane of incidence, called polarization P,
the reflector element having a greater reflectivity, over a range of angles of incidence including the angle of incidence, for light with polarization P than for light with rectilinear polarization perpendicular to the plane of incidence, called polarization S.

12. The device according to claim 11, wherein the reflector element has a greater reflectivity over the range of angles of incidence for light with polarization P than for light with a different polarization.

13. The device according to claim 11, wherein the reflectivity of the reflector element for light with polarization P, over the range of angles of incidence, is greater than or equal to 10 percent.

14. The device according to claim 11, wherein the reflectivity of the reflector element for light with polarization P, over the range of angles of incidence, is greater than or equal to 15 percent.

15. The device according to claim 11, wherein the reflectivity of the reflector element for light with polarization P, over the range of angles of incidence, is greater than or equal to 20 percent.

16. The device according to claim 11, wherein the reflectivity of the reflector element for light with polarization P, over the range of angles of incidence, is greater than or equal to 40 percent.

17. The device according to claim 11, wherein the reflectivity of the reflector element for light with a polarization different from a polarization P over the range of angles of incidence, is less than or equal to 10 percent.

18. The device according to claim 11, wherein the reflectivity of the reflector element for light with a polarization different from a polarization P over the range of angles of incidence, is less than or equal to 5 percent.

19. The device according to claim 11, wherein the range of angles of incidence extends over at least 20 degrees.

20. The device according to claim 11, wherein the range of angles of incidence extends over at least 40 degrees.

21. The device according to claim 11, wherein the range of angles of incidence extends over at least 60 degrees.

22. The device according to claim 11, wherein the range of angles of incidence comprises a Brewster angle with respect to the input optical interface.

23. The device according to claim 11, wherein the information projection source is configured for emitting the incident beam with an angle of incidence chosen so that the portion of the incident beam transmitted by the reflector element arrives on the output optical interface at an angle substantially equal to the Brewster angle with respect to the output optical interface.

24. The device according to claim 11, wherein the reflector element comprises a stack of dielectric layers.

25. The device according to claim 11, wherein the transparent support is a windscreen of a vehicle, the reflector element being advantageously arranged over the entire external face of the input optical interface.

26. A vehicle comprising a head-up display device according to claim 11.
